(19) United States
(12) Patent Application Publication
(10) Pub. No.: US 2016/0065773 A1
(43) Pub. Date: Mar. 3, 2016

(54) IMAGE READING APPARATUS, IMAGE FORMING APPARATUS, AND IMAGE READING METHOD

(71) Applicant: KYOCERA DOCUMENT SOLUTIONS INC., Osaka (JP)

(72) Inventor: Michiko TASHIRO, Osaka (JP)

(73) Assignee: KYOCERA DOCUMENT SOLUTIONS INC., Osaka (JP)

(21) Appl. No.: 14/839,964

(22) Filed: Aug. 29, 2015

(30) Foreign Application Priority Data
Aug. 29, 2014 (JP) 2014-175413

(51) Int. Cl. H04N 1/00; H04N 1/38; H04N 1/23

(52) U.S. Cl. CPC H04N 1/00803; H04N 1/233; H04N 1/38; H04N 2201/0094; H04N 2201/0081

(57) ABSTRACT

Provided is an image forming apparatus that converts a manuscript into an electronic file except for a blank page. A blank paper elimination processing part reads a manuscript, determines whether or not a blank paper for each page, and converts the manuscript into an electronic file except for a blank paper determining page determined to be a blank paper. An insertion page receiving part receives designation of the page inserted in the electronic file when there is restoration instruction for the blank paper determining page. Blank paper restoration processing part, when the page received by the insertion page receiving part is the blank paper determining page, as corresponded to the page number of the manuscript of the received page, the manuscript of the received page is converted into electronic file form and inserts between the pages of the electronic file.

### INCORPORATION BY REFERENCE

This application is based on and claims the benefit of priority from Japanese Patent Application No. 2014-175413 filed on Aug. 29, 2014, the contents of that are hereby incorporated by reference.

### BACKGROUND

The present disclosure is related with an image reading apparatus, an image forming apparatus, and an image reading method that can read a manuscript and can convert a manuscript into an electronic file except for a blank page.

A typical image forming apparatus provided with image reading apparatuses, such as a scanner, determines whether or not a blank page based on rate of black pixels in each page of read manuscript. Then, if there is a blank page, it can convert into an electronic file with removing for the blank page from the manuscript. In such a technology, attribution information for an arrangement order of the manuscript, an identifier of the front or rear surface, and an arrangement order of the page is attached to the electronic data made except for the blank page. Then, based on the attribution information, from the electronic data made except for the blank page, page configuration in which the blank page is inserted completely as like the original can be restored.

### SUMMARY

The image reading apparatus of the present disclosure is provided with a blank paper elimination processing part, an insertion page receiving part, and a blank paper restoration processing part. The blank paper elimination processing part reads a manuscript and determines whether it is a blank paper for each page and converts the manuscript into an electronic file except for a blank paper determining page determined to be a blank paper. When the insertion page receiving part receives a restoration instruction for the blank paper determining page, designation of the page inserted in the electronic file is received. The blank paper restoration processing part, when the page received by the insertion page receiving part is the blank paper determining page, corresponds to the page number of the manuscript of the received page, the manuscript of the received page is converted into electronic file form, and inserts between the pages of the electronic file. An image reading method of the present disclosure reads a manuscript, determines whether or not it is a blank paper for each page, and converts the manuscript into an electronic file except for a blank paper determining page determined to be a blank paper. When there is a restoration instruction for the blank paper determining page, designation of the page inserted in the electronic file is received. When the received page is the blank paper determining page, it corresponds to the page number of the manuscript of the received page, converts the manuscript of the received page into electronic file form, and inserts between the pages of the electronic file.

### BRIEF DESCRIPTION OF THE DRAWINGS

FIG. 1 is a cross section of the image forming apparatus of the embodiment related to the present disclosure;

FIG. 2 is a block diagram showing an outline control configuration of the image forming apparatus shown in FIG. 1;

FIG. 3 is a flow chart that shows a process flow of the Pdf conversion processing part shown in FIG. 2;

FIG. 4 is a flow chart that shows a process flow of the Pdf conversion processing part shown in FIG. 2; and

FIG. 5 shows an example of a screen notifying a manuscript page number of a page determined to be a blank paper.

### DETAILED DESCRIPTION

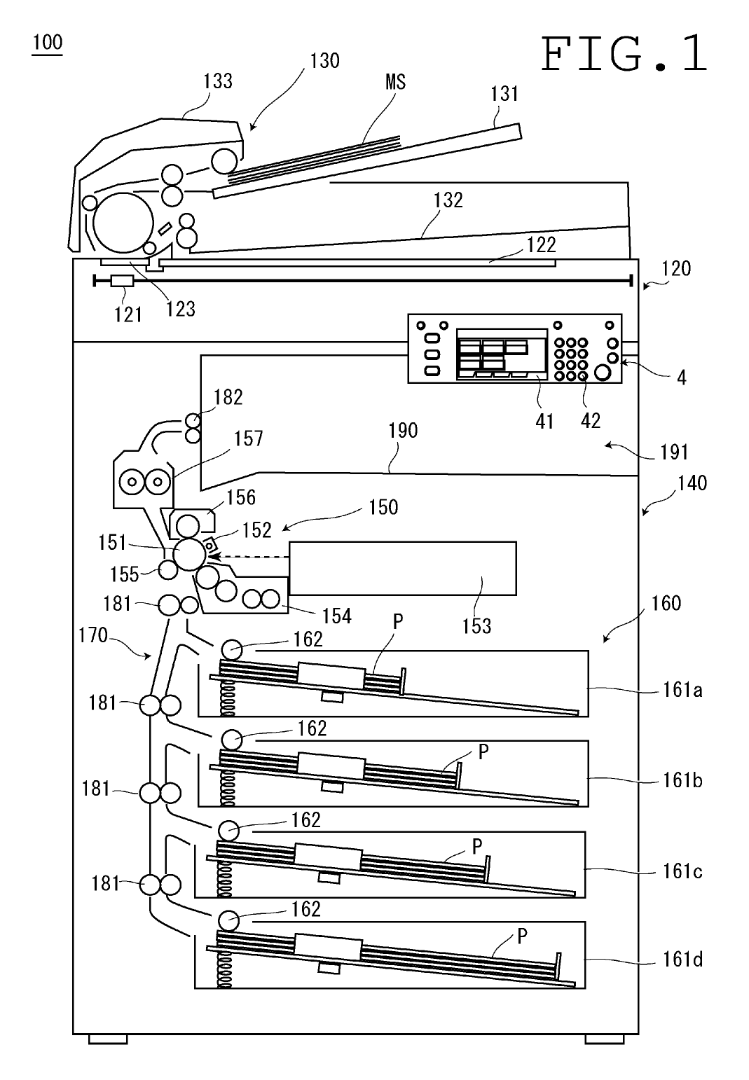

Then, an embodiment of the present disclosure is explained in detail with reference to drawings. Image forming apparatus 100 of the embodiment of the present disclosure is an MFP that has a duplication function, a print function, a scanner function, or the like. As refer to FIG. 1, image forming apparatus 100 includes manuscript reading part 120, manuscript feeding part 130, and printing part 140. Manuscript reading part 120 is allocated in the upper part of printing part 140. Manuscript feeding part 130 is allocated in the upper part of manuscript reading part 120.

Operation panel 4 is allocated in a side in front of image forming apparatus 100. Operation panel 4 performs a setup of image forming apparatus 100 and instructions of operation. In operation panel 4, touch panel 41 and manual operation button 42 are provided. A user operates with operation panel 4 and inputs instructions. Thereby, various kinds of setup of image forming apparatus 100 are performed. Also, various functions, such as image formation, are executed. Touch panel 41 is provided on a display surface of a display part. The display part displays various operation keys that receive operational input. Touch panel 41 detects an input by press of fingertip or a stylus, or the like, by the operator. Touch panel 41 outputs a signal corresponding to a position where the input is detected. Thereby, touch panel 41 receives the operation to the operation key displayed on the display part. Manual operation button 42 includes a start button, a stop/clear button, a reset button, a numeric keypad, or the like. The start button instructs starting image formation by the user. The stop/clear button is used when stopping the image formation. The reset button is used when making various setup of image forming apparatus 100 into a default.

Manuscript reading part 120 is provided with scanner 121, platen glass 122, and manuscript reading slit 123. Scanner 121 has an exposure lamp, an image sensor, or the like. Scanner 121 is configured movable to a transportation direction of manuscript MS by manuscript feeding part 130. Platen glass 122 is a manuscript stand composed of transparent members, such as glass. Manuscript reading slit 123 has a slit formed in orthogonal orientation for the transportation direction of manuscript MS by manuscript feeding part 130.

Manuscript feeding part 130 is configured as retractable. The upper surface of platen glass 122 is made to open wide by lifting up manuscript feeding part 130. Thereby, manuscript MS can be placed on platen glass 122. When reading manuscript MS placed on platen glass 122, scanner 121 is moved to the position that faces platen glass 122. Then, scanner 121 reads manuscript MS by scanning manuscript MS placed on platen glass 122 and obtains image data.

Also, manuscript feeding part 130 includes manuscript mounting part 131, manuscript discharge part 132, and manuscript transport mechanism 133. Manuscript MS placed in manuscript mounting part 131 feed outs one sheet at a time in order by manuscript transport mechanism 133. Manuscript MS is conveyed in a position that faces manuscript reading slit 123 in manuscript reading part 120. Manuscript MS is discharged by manuscript discharge part 132 after that. When reading manuscript MS conveyed by manuscript feeding part 130, scanner 121 is moved to a position that faces manuscript reading slit 123. Scanner 121 reads manuscript MS at manuscript reading slit 123 synchronizing with the conveying action of manuscript MS by manuscript feeding part 130. Thereby, image data is obtained.

Printing part 140 includes image formation part 150. Also, printing part 140 includes feeding part 160, carrying path 170, conveying roller 181, ejection roller 182, and in-body discharging tray 190. In-body discharging tray 190, which is a discharging unit, is provided in discharging space 191 formed between manuscript reading part 120 and printing part 140.

Feeding part 160 includes sheet paper cassette 161 a-d and feed roller 162. Sheet paper cassette 161 a-d contains recording paper P. Feed roller 162 feeds out one sheet of recording paper P at a time to carrying path 170 from sheet paper cassette 161 a-d. Feed roller 162, conveying roller 181, and ejection roller 182 function as a conveyance part, and recording paper P is conveyed. Recording paper P, which is fed out to carrying path 170 with feed roller 162, is conveyed to image formation part 150 by conveying roller 181.

Image formation part 150 includes photo conductor drum 151, charging part 152, exposure part 153, developing part 154, transfer part 155, cleaning part 156, and fixing part 157. Exposure part 153 is an optical unit provided with a laser device, a mirror, or the like. Exposure part 153 scans a laser beam based on image data. Exposure part 153 exposes photo conductor drum 151 electrified by charging part 152. Thereby, an electrostatic latent image is formed in the surface of photo conductor drum 151. Developing part 154 is a development unit that develops electrostatic latent image formed on photo conductor drum 151 by using a toner. Developing part 154 makes toner image based on the electrostatic latent image form on photo conductor drum 151. Transfer part 155 makes recording paper P transfer the toner image formed on photo conductor drum 151 in developing part 154. Fixing part 157 heats recording paper P with which the toner image is transferred by transfer part 155 and makes fix the toner image to recording paper P.

Recording paper P, which the record is carried out by image formation part 150, is led by ejection roller 182 and output to in-body discharging tray 190 as a printed matter.

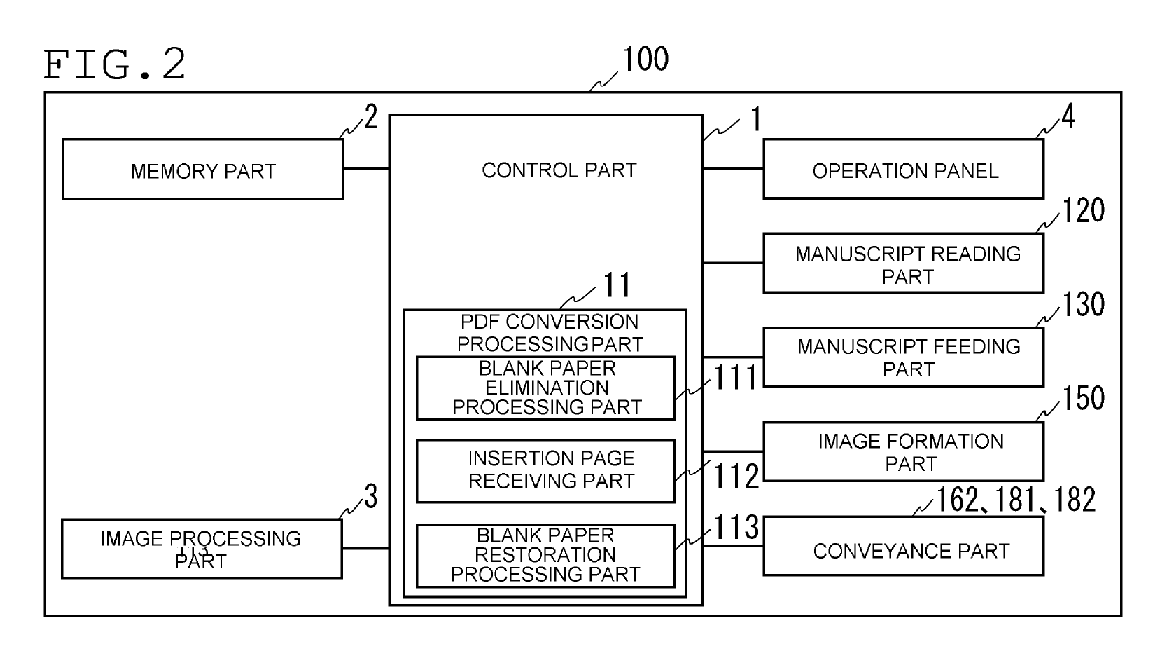

In FIG. 2, a block diagram showing an outline control configuration of image forming apparatus 100 is shown. Above-mentioned operation panel 4, manuscript reading part 120, manuscript feeding part 130, image formation part 150, and conveyance part (feed roller 162, conveying roller 181, ejection roller 182) are connected to control part 1. Each part is operation-controlled by control part 1. Also, memory part 2 and image processing part 3 are connected with control part 1.

Memory part 2 is a memory part including a non-transitory recording medium that the image data obtained by reading the manuscript by manuscript reading part 120 is memorized.

Image processing part 3 is a part that performs specified image processing for the image data. In image processing part 3, for example, a scaling process, and an image improvement process, such as density control and gradation adjustment, are performed.

Control part 1 is an information processing part, such as a microcomputer provided with a non-transitory recording medium. The control program for operation-controlling image forming apparatus 100 is memorized in the recording medium. Control part 1 reads the control program memorized in the recording medium and makes expand the control program to the recording medium. Thereby, a whole device is controlled.

Also, control part 1 functions as Pdf conversion processing part 11 that converts the manuscript read via manuscript reading part 120 into an electronic file. An example of the electronic file is a PDF document. The manuscript read via manuscript reading part 120 may be converted into electronic files, such as a Word (registered trademark) document instead of the PDF document. Also, Pdf conversion processing part 11 has blank paper elimination processing part 111, insertion page receiving part 112, and blank paper restoration processing part 113.

Blank paper elimination processing part 111 determines whether each page of the read manuscript is a blank paper or not when having a removal setup for the blank paper manuscript. Blank paper elimination processing part 111 has function that remove a blank page from a manuscript when there is a blank page and converts the manuscript into a PDF document. Insertion page receiving part 112 has function to receive designation of a page to restore among the pages of the blank paper determined by blank paper elimination processing part 111. The page to restore is inserted among either of the pages in the PDF document. Also, blank paper restoration processing part 113 compares whether the page that insertion page receiving part 112 received is the blank paper determining page. Blank paper restoration processing part 113, when it is the blank paper determining page, has function that inserts and restores the page among either of the pages in the PDF document.

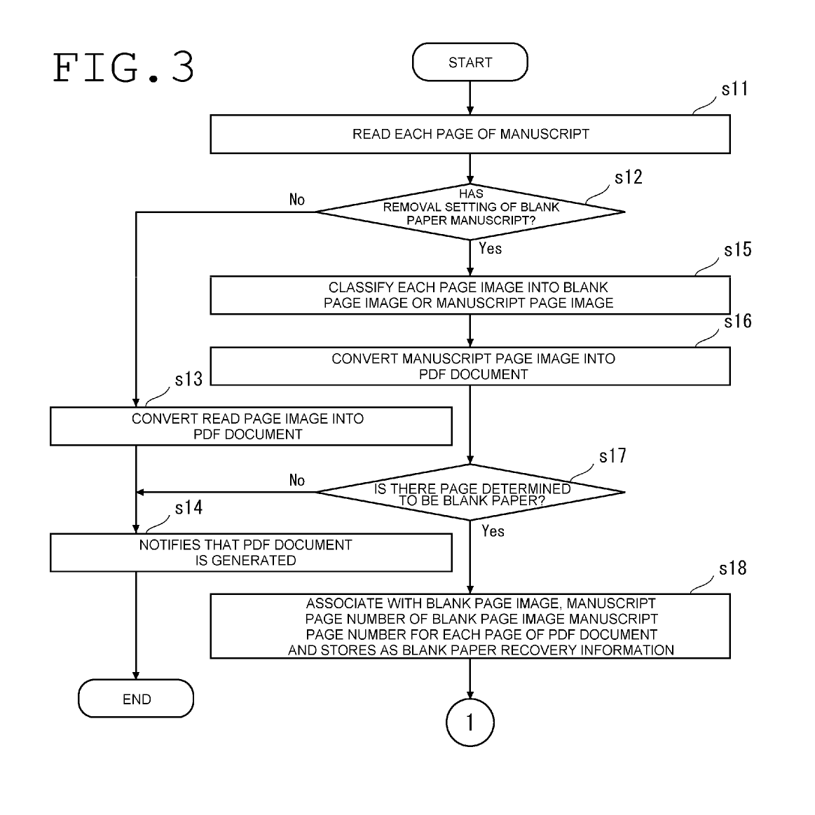

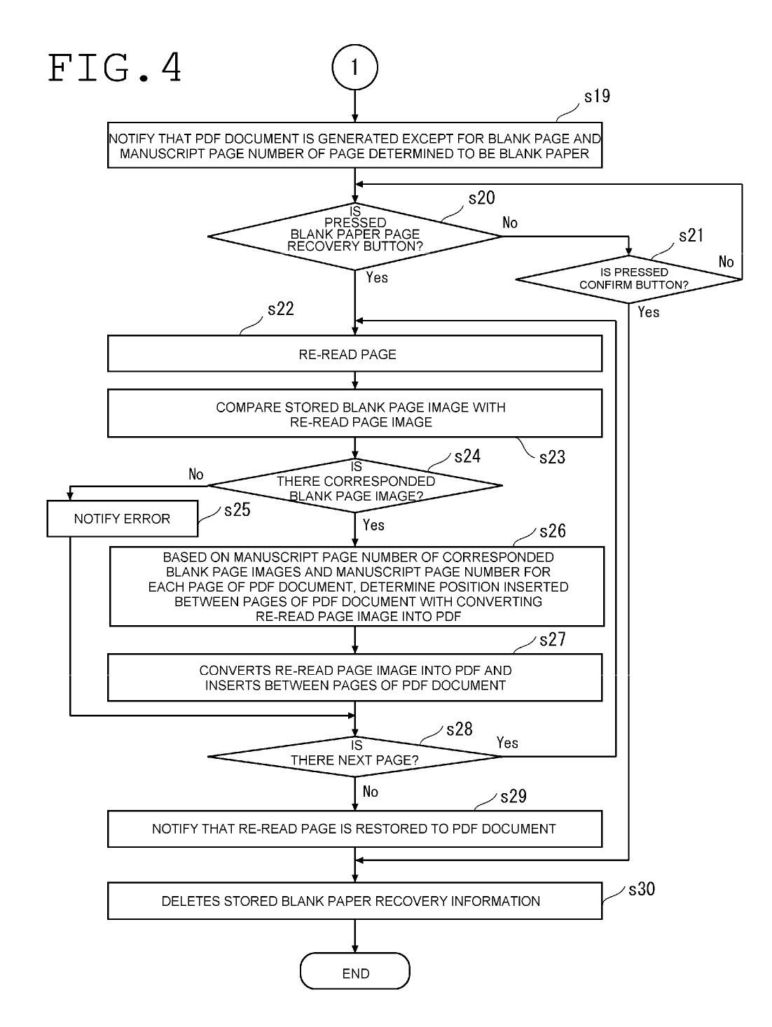

With reference to FIG. 3 and FIG. 4, a process flow of Pdf conversion processing part 11 is explained in detail.

Firstly, as shown in FIG. 3, Pdf conversion processing part 11 reads each page of the set manuscript (Step s11). Continuing, Pdf conversion processing part 11 determines whether or not having a removal setup for the blank paper manuscript (Step s12). A user can set up the removal setup for the blank paper manuscript, for example, via operation panel 4 or a printer driver.

When not having the removal setup for the blank paper manuscript (No in Step s12), Pdf conversion processing part 11 converts the read page image group into a PDF document (Step s13). Then, Pdf conversion processing part 11 notifies that the PDF document is generated (Step s14) and ends the present process.

On the other hand, when the removal setup for the blank paper manuscript is performed (Yes in Step s12), blank paper elimination processing part 111 in Pdf conversion processing part 11 classifies each page image of the manuscript into a blank page image or a manuscript page image (Step s15). For example, blank paper elimination processing part 111 determines whether or not the blank paper based on a rate of black pixels in a page for each page of the manuscript. Blank paper elimination processing part 111 is classified into the blank page image when it is a blank paper, and it may be classified into the manuscript page image when it is not a blank paper. Also, blank paper elimination processing part 111 may determine whether it is the blank paper based on the brightness value of a page for each page of the manuscript. After completing a classification of each page image, the manuscript page image group determined as not being the blank paper by blank paper elimination processing part 111 is converted into the PDF document (Step s16).

Continuing, Blank paper elimination processing part 111 determines whether or not there is any page determined to be the blank paper (Step s17). If there is no page determined to be the blank paper (No in Step s17), blank paper elimination processing part 111 notifies that the PDF document is generated (Step s14) and ends the present process.

On the other hand, if there is a page determined to be the blank paper (Yes in Step s17), blank paper elimination processing part 111 associates with the blank page image, the manuscript page number of the blank page image, and the manuscript page number for each page of the generated PDF document. The blank page image is an image of the page determined to be the blank paper. Blank paper elimination processing part 111 stores them as blank paper recovery information in memory part 2 (Step s18).

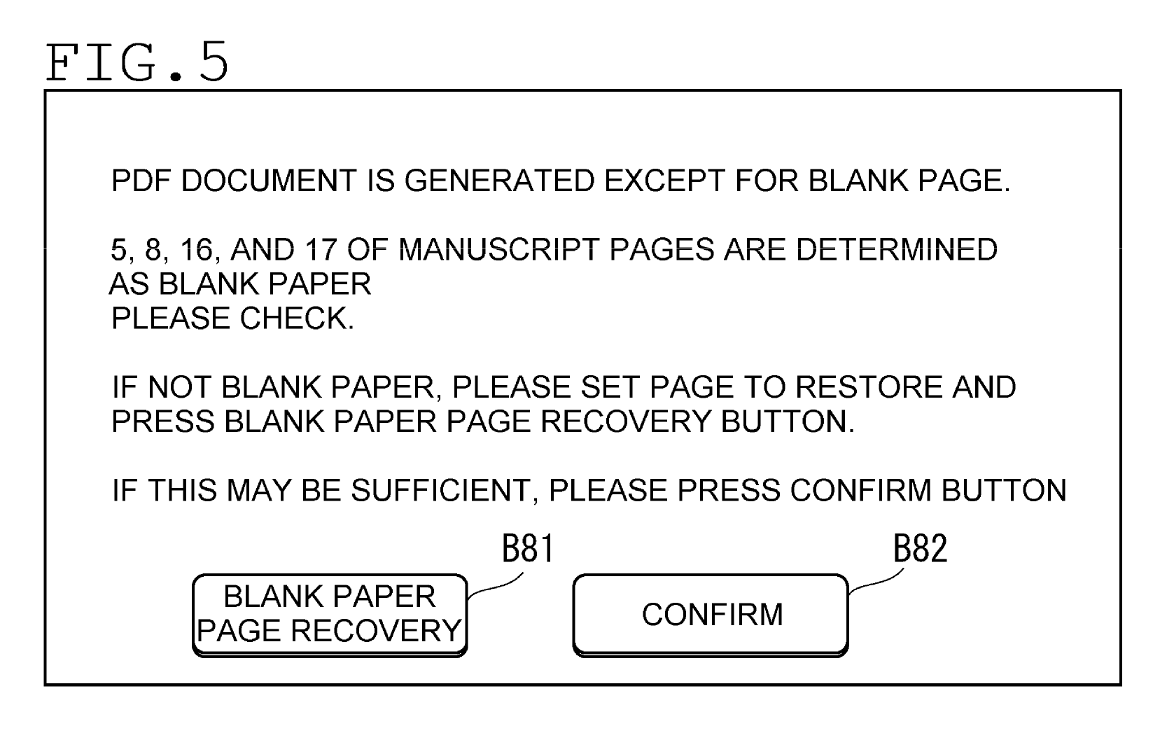

Continuing, as shown in FIG. 4, blank paper elimination processing part 111 notifies the PDF document is generated except for the blank page and the manuscript page number of the page determined to be the blank paper (Step s19). For example, as shown in FIG. 5, on operation panel 4, a message, such as, “PDF document is generated except for blank page. 5, 8, 16, and 17 of manuscript pages are determined as blank paper. Please check. If not blank paper, please set page to restore and press blank paper page recovery button. If this may be sufficient, please press confirm button” is displayed. Also, on operation panel 4, “Blank paper page recovery” button B81 and “confirm” button B82 are displayed. The user checks the page determined to be the blank paper according to the message. If there is a page as the blank paper by erroneous decision although there is a description of a character, or the like, a user set only of the page by erroneous-decision to manuscript reading part 120, again. Then, “blank paper page recovery” button B81 is pressed. On the other hand, if there is no page by the erroneous decision, “confirm” button B82 is pressed.

Continuing, blank paper restoration processing part 113 in Pdf conversion processing part 11 determines whether or not “blank paper page recovery” button B81 is pressed (Step s20). If “blank paper page recovery” button B81 is not pressed (No in Step s20,) it is determined whether or not “confirm” button B82 is pressed (Step s21). If neither “blank paper page recovery” button B81 nor “confirm” button B82 is pressed (No in Step s21,) a process returns to Step s20. If “confirm” button B82 is pressed (Yes in Step s21,) blank paper restoration processing part 113 deletes the stored blank paper recovery information (Step s30) and ends the present process.

If “blank paper page recovery” button B81 is pressed (Yes in Step s20,) blank paper restoration processing part 113 performs re-reading of the manuscript page set by the user (Step s22.)

This manuscript page is a page in which the user expects to restore. Continuing, blank paper restoration processing part 113 compares the page image obtained by re-reading with the blank page image in the stored blank paper recovery information (Step s23.)
Blank paper restoration processing part 113 determines whether or not the page image and the stored blank page image is corresponded (Step s24.)
In addition, manuscript page number of the page that wishes to restore may be designated by the user. However, by re-setting and re-reading the manuscript of the page that wishes to restore and by receiving designation of the page that wishes to restore, a designation mistake in the page by an operational error, or the like, can be prevented.

If the page image that is re-read and blank page image are not corresponded (No in Step s24,) blank paper restoration processing part 113 notifies, for example, an error such as “not page determined to be blank paper” (Step s25) and advances a process to Step s28.

On the other hand, if the re-read page image and the stored blank page image are corresponded (Yes in Step s24), blank paper restoration processing part 113 determines a position to be inserted between the pages as configured the PDF document with converting the re-read page image into PDF (Step s26.) Blank paper restoration processing part 113 performs this process based on the manuscript page number of the corresponded blank page image and the manuscript page number for each page of the PDF document. In addition, if there is a plurality of the corresponded blank page images, blank paper restoration processing part 113 may let a user input the manuscript page number of the re-read page image. In this case, blank paper restoration processing part 113 is processed as matched the blank page image corresponding to the input manuscript page number and re-read page image.

Continuing, blank paper restoration processing part 113 converts the read page image into PDF, and inserts between the pages that configures the PDF document (Step s27). Then, blank paper restoration processing part 113 determines whether or not there is next page (Step s28.)

If there is the next page (Yes in Step s28,) the process from Step s22 to Step s28 is repeated.

If there is no next page (No in Step s28,) blank paper restoration processing part 113 notifies that the re-read page is restored to the PDF document (Step s29.)

Blank paper restoration processing part 113 deletes the stored blank paper recovery information (Step s30) and ends the present process.

Thus, in the present embodiment, when it converts from a manuscript into a PDF document except for a blank page, in the pages determined to be a blank paper and removed from the manuscript, the page requesting by a user can be inserted and be restored in the PDF document.

In detail, in the present embodiment, by blank paper elimination processing part 111, when it converts from the manuscript into the PDF document except for the blank page, the page image determined to be the blank paper and its manuscript page number, and the manuscript page number of each page of the PDF document are associated with and are stored as blank paper recovery information. Therefore, only the manuscript page that the user hopes to insert in the PDF document is set, and “blank paper page recovery” button B81 is pressed. Then, the re-setting manuscript page is read, again, and the stored page image are compared with the read page image. Then, based on the manuscript page number of the corresponded blank page image and manuscript page number for each page of the PDF document, the read page image is converted into PDF and is inserted between the pages configuring the PDF document, automatically. Therefore, even if the user does not need to cancel the blank paper manuscript removal setup and to re-generate a PDF document, in the page that is determined to be the blank paper and is removed, only the page that hopes to be included in the PDF document is read, again. Thereby, the PDF document in which the page is included can be generated. Also, even if the user does not designate the position to insert the page in that case, an insertion position is determined, automatically, and thus a burden for the user can be reduced. Also, blank paper restoration processing part 113, when not necessary to insert the blank paper determining page in the PDF, and when finishing to insert the re-read page in the PDF document, deletes the blank paper recovery information, which becomes unnecessary. For this reason, a storage area can be used, effectively.

In summarizing, in a typical case, it determines whether it is a blank page or not based on a rate of a number of black pixels in each page. For this reason, actually, when characters are written but few characters, an erroneous decision as a blank page is performed. For this reason, the page by the erroneous decision is not included in the electronic file. However, in the typical case, all the pages determined to be the blank page are inserted and are restored to the electronic file. Accordingly, only the page by the erroneous decision to the blank paper is not able to be inserted in the electronic file, and it is not able to be restored.

As compared with this, according to the present disclosure, a manuscript is read and is determined whether or not a blank paper for each page. Then, when the manuscript is converted into an electronic file except for the page determined to be the blank paper, the page specified in the pages determined to be the blank page can be inserted in the electronic file.

The present disclosure is not limited to the embodiment mentioned above, and it cannot be overemphasized that it can change of all sorts in the range that does not deviate from the aim of the present disclosure.

For example, in the above-mentioned process, the re-read page image is converted into PDF and is inserted between the pages configuring the PDF document. However, it is only needed that the manuscript of the re-read page to be converted and to be inserted in the PDF. For example, in the stored blank paper determining page image, the blank paper determining page image that is corresponded with the re-read page image may be converted and be inserted in the PDF.

What is claimed is:

1. An image reading apparatus comprising:
a blank paper elimination processing part that reads a manuscript, determines a blank paper or not for each page, excludes a blank paper determining page for being determined to be the blank paper and converts the manuscript into an electronic file;
an insertion page reception part that, when having a restoration instruction for the blank paper determining page, receives designation of a page inserted in the electronic file; and
a blank paper restoration processing part that, when the page received by the insertion page reception part is the blank paper determining page,
corresponds to a page number of the page of the manuscript received by the insertion page reception part,
converts the page of the manuscript received by the insertion page reception part into the electronic file form, and
inserts between pages of the electronic file.

2. The image reading apparatus according to claim 1, wherein
the insertion page reception part receives the designation of the page inserted in the electronic file by re-reading a page inserted in the electronic file.

3. The image reading apparatus according to claim 1, wherein
the blank paper elimination processing part
associates and stores an image of the blank paper determining page, manuscript page number of the blank paper determining page, and the manuscript page number of each page converted into the electronic file, and
the blank paper restoration processing part
compares an image of a page received by the insertion page reception part with a stored image of the blank paper determining page, and
when there is an image of the blank paper determining page corresponded with the image of the page received by the insertion page reception part,
based on the manuscript page number of the image of corresponded blank paper determining page and the manuscript page number of each page converted into the electronic file,
converts image of a page received by the insertion page reception part into the electronic file form, and
inserts between pages of the electronic file.

4. The image reading apparatus according to claim 1, wherein
the blank paper restoration processing part,
when converting the image of the page received by the insertion page reception part into the electronic file form and inserting between the pages of the electronic file,
deletes the image of the blank paper determining page become unnecessary, the manuscript page number of the blank paper determining page, and the manuscript page number of each page converted into the electronic file.

5. The image reading apparatus according to claim 1, wherein
the blank paper elimination processing part notifies the manuscript page number of the blank paper determining page.

6. An image forming apparatus provided with the image reading apparatus according to claim 1.

7. An image reading method comprising the steps of:
reading a manuscript and determining a blank paper or not for each page;
converting the manuscript into an electronic file except for a blank paper determining page determined to be the blank paper;
receiving, when having a restoration instruction for the blank paper determining page, designation of a page inserted in the electronic file;
converting, when a received page is the blank paper determining page, a manuscript of a received page into electronic file form corresponding to page number of the manuscript of the received page; and
inserting between pages of the electronic file.
